(19) United States
(12) Patent Application Publication
(10) Pub. No.: US 2007/0257546 A1
(43) Pub. Date: Nov. 8, 2007

(54) WHEEL CENTERING TOOL AND METHOD

(76) Inventor: Marlus Mitchel, Hopkins, SC (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/743,622

(22) Filed: May 2, 2007

Related U.S. Application Data
(60) Provisional application No. 60/796,823, filed on May 2, 2006.

(51) Int. Cl. B60B 1/00

(52) U.S. Cl. 301/35.627

(57) ABSTRACT

A centering tool for aligning a vehicle rim relative to a hub of a vehicle, wherein the rim includes a plurality of mounting holes for receiving axially extending studs from the hub. The tool includes a body having a first end and an opposite second end. The first end is adapted to engage a torque applying tool. The body has an outer cylindrical surface that extends from the second end and allows generally axial insertion of the tool through one of the mounting holes in the rim while substantially limiting the radial movement of the rim relative to the centering tool. A bore extends longitudinally through the body and through both the first end and second end of the body. The bore has threads for threadingly engaging a stud extending through the one of the mounting holes in the rim. A cam surface is formed on the second end of the body. The cam surface is angled relative to a longitudinal axis of the body such that axial displacement of the centering tool onto the stud extending through the one of the mounting holes in the rim promotes a centering of the rim relative to the hub along at least one axis.

### REFERENCE TO RELATED APPLICATIONS

This application claims priority to U.S. provisional patent application No. 60/796,823, which was filed May 2, 2006 and is incorporated herein by reference in its entirety.

### FIELD OF THE INVENTION

The invention relates to equipment used for mounting vehicle rims to vehicles. More particularly, the invention relates to a device for centering a rim relative to mounting lugs to facilitate assembly of the rim to the vehicle.

### BACKGROUND OF THE INVENTION

Vehicle rims are typically mounted on a vehicle using lug nuts. The rims include a plurality of holes that are arranged about the center axis and positioned to receive studs extending axially from the axles or hub. The holes are oversized relative to the stud diameters. The rims are mounted to the vehicle by aligning the holes to the studs and at the same time pushing the rim toward the vehicle. The rim must then be held in a substantially aligned position while threading the lug nuts onto the studs, so as to lock the rim in position. Aligning and holding the rim in the aligned position is typically done manually and can be difficult, especially for large truck tires.

U.S. Pat. No. 7,178,880 (Andersen) discloses a wheel centering pin, which can be used to help center a rim prior to installation of the lug nuts. The centering pin is cylindrical in shape. One end of the pin is closed, while an opposite end of the pin is open to reveal a center bore that is threaded for engaging the threads on the stud. The outer surface of the centering pin is uniform in diameter and is sized to slide into and substantially fill the holes in the rim. Three of the centering pins as disclosed in Andersen are required to locate the rim to the axle prior to installation of the lug nuts.

There are shortcomings, however, with the centering pin design as disclosed in Andersen. First, the uniform diameter of the centering pin in Andersen is not effective in locating a rim that has been previously deformed. A previously deformed rim typically has holes that are reduced in size and/or not round. The centering pin disclosed in Andersen also has a blunt end, which would not function to center the rim where the hole in the rim is reduced in size and/or not round. Second, the centering pin in Anderson is not usable with studs that are longer than the length of the center bore. A long stud would reach the closed end of the centering pin before providing a centering effect on the rim relative to the axle or hub.

It, therefore, remains desirable to provide an improved center pin or tool design that is effective at centering rims when the rims are deformed and/or the studs are longer than the length of the tool.

### SUMMARY OF THE INVENTION

According to one aspect of the invention, a centering tool is provided for aligning a vehicle rim relative to a hub of a vehicle, wherein the rim includes a plurality of mounting holes for receiving axially extending studs from the hub. The tool includes a body having a first end and an opposite second end. The first end is adapted to engage a torque applying tool. The body has an outer cylindrical surface that extends from the second end and allows generally axial insertion of the tool through one of the mounting holes in the rim while substantially limiting the radial movement of the rim relative to the centering tool. A bore extends longitudinally through the body and through both the first end and second end of the body. The bore has threads for threadingly engaging a stud extending through the one of the mounting holes in the rim. A cam surface is formed on the second end of the body. The cam surface is angled relative to a longitudinal axis of the body such that axial displacement of the centering tool onto the stud extending through the one of the mounting holes in the rim promotes a centering of the rim relative to the hub along at least one axis.

According to another aspect of the invention, a method is provided for installing a rim onto a hub of a vehicle, wherein the hub includes a plurality of outwardly extending studs that extend through a corresponding plurality of holes formed in the rim. The method includes the steps of placing the rim onto the hub so that at least two of the plurality of studs extend through respective holes in the rim; inserting first and second centering tools as defined above into the respective holes in the rim to engage the at least two of the plurality of studs; threading the first centering tool to correct misalignment of the rim relative to the hub along a first axis; threading the second centering tool to correct misalignment of the rim relative to the hub along a second axis, such that the rim is then substantially aligned relative to the hub along two axes; threading lug nuts onto the remaining studs to hold the rim in substantial alignment with the hub, and replacing the first and second centering tools with lug nuts to securely fasten the rim to the hub for road use.

According to another aspect of the invention, a method is provided for installing a rim onto a hub of a vehicle, wherein the hub includes a plurality of outwardly extending studs that extend through a corresponding plurality of holes formed in the rim. The method includes the steps of: placing the rim onto the hub so that at least two of the plurality of studs extend through respective undersized holes in the rim; threading the first and second centering tools as defined above onto the studs that extend through the respective undersized holes in the rim; centering the undersized holes in the rim relative to the respective studs using the only the cam surfaces of the first and second centering tools, wherein the undersized holes cannot accept the outer cylindrical surfaces of the first and second centering tools therethrough; threading lug nuts onto the remaining studs to hold the rim in substantial alignment with the hub; and replacing the first and second centering tools with lug nuts to securely fasten the rim to the hub for road use.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a side elevational view of a wheel centering tool according to one embodiment of the invention;

FIG. 2 is an end view of the wheel centering tool of FIG. 1;

FIG. 3a is a cross sectional view of the tool just prior to engaging a rim to be installed onto a hub;

FIG. 3b is an enlarged view as indicated by the circle in FIG. 3a;

FIG. 4 is a perspective view of a pair of tools being used to center a rim relative studs that extend from a vehicle hub;

FIG. 5 is a front elevational view illustrating the rim after it has been centered relative to the studs; and

FIG. 6 is a side elevational view of a second embodiment of the centering tool, which has been cutaway to show the threading engagement between the tool and one of the studs.

### DETAILED DESCRIPTION OF THE INVENTION

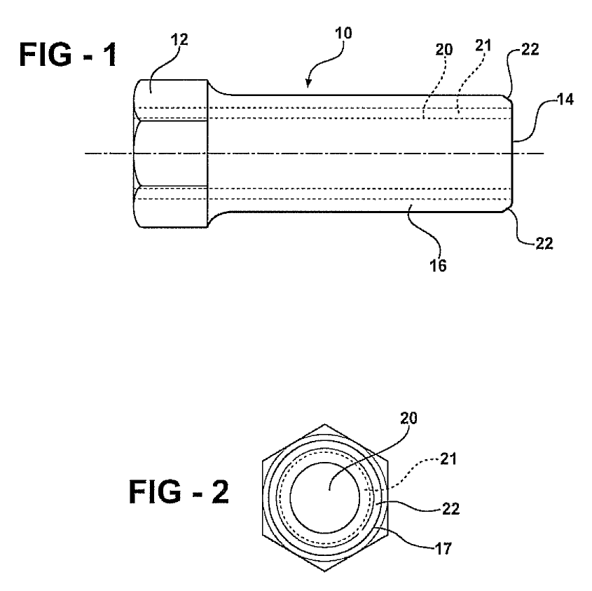

Referring to FIGS. 1-5, a centering tool for centering a rim relative to an axle or hub of a vehicle prior to securing the rim to the hub with lug nuts is generally indicated at 10. The tool 10 includes opposite first 12 and second 14 ends. The first end 12 is adapted to engage a wrench or other conventional torque applying tools. In one embodiment, the first end 12 is shaped or dimensioned similar to a lug nut so as to be compatible with the same tools used to apply torque to the lug nuts during installation of the rim to the vehicle hub.

The tool 10 includes a substantially cylindrical body 16 that extends axially between the first 12 and second 14 ends. A bore 20 extends longitudinally through the body 16 and extends through both ends 12, 14 of the body 16. The bore 20 is centered with respect to an outer cylindrical surface 17 of the body 16. The bore 20 is provided with threads 21 to threadingly engage any one of the studs extending axially from the hub. Thus, the threads 21 in the bore 20 are dimensioned substantially like the threads in the lug nuts that are used for final installation of the rim onto the hub. The outer cylindrical surface 17 of the body 16 is sized to allow the tool 10 to pass axially through the holes in the rim and at the same time substantially limit radial movement of the rim relative to the tool 10 as the tool 10 is threaded onto one of the studs extending from the hub.

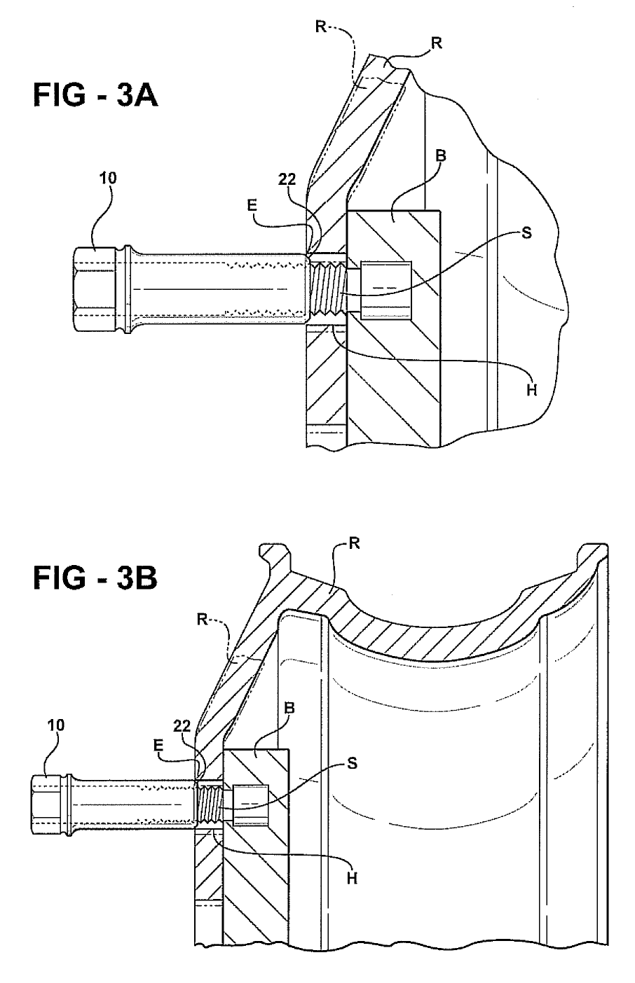

The second end 14 of the tool 10 also includes a beveled cam surface 22. In FIGS. 3a and 3b, the rim R is shown misaligned relative to the hub in dotted lines and aligned in solid lines. The cam surface 22 facilitates initial insertion of the tool 10 through the hole H in the rim R by engaging an edge E of the rim R surrounding the hole H. The cam surface 22 tends to center the rim R relative to the hub B as the tool 10 is threaded onto the stud S and the cam surface 22 is displaced axially toward the hub B. As the tool 10 is threaded onto the stud S, the outer cylindrical surface 17 eventually extends through the hole H and maintains the hole H in alignment with the stud S. In situations where the hole H is too small or otherwise deformed, the cam surface 22 can still engage the edge E to substantially align the hole H relative to the stud S without further need for the outer cylindrical surface 17 to extend through the hole H. The cam surface 22 has an angle that ranges between 35 and 55 degrees relative to the longitudinal axis of the body 16 and the length of the cam surface 22 in the direction of the longitudinal axis of the tool 10 ranges between 2 mm to 5 mm. In one specific embodiment, a cam surface 22 with an angle of approximately forty five degrees has been shown to be effective at aligning the hole relative to the stud or otherwise the rim relative to the hub.

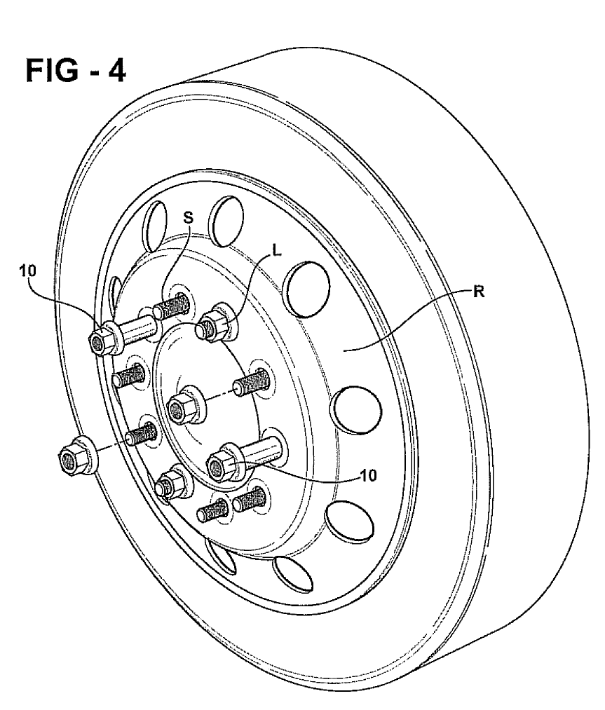

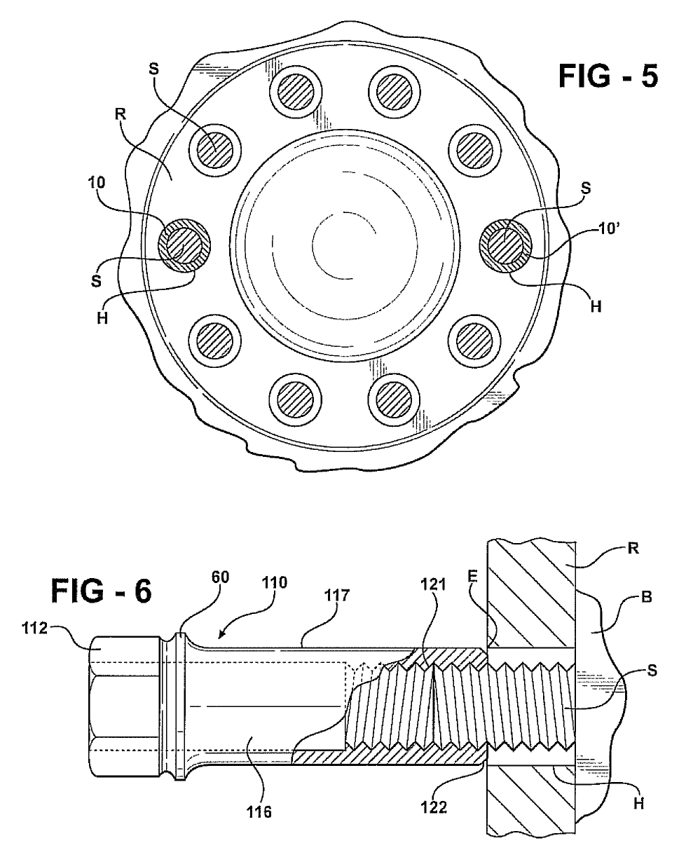

In use, the rim 30 is mounted to the hub H so that the studs S extend through the respective holes H in the rim 30. The rim 30 is loosely supported by the studs S and, as a result, misaligned generally due to gravity. At least one tool 10 is threaded onto one of the studs S. As the tool 10 is tightened, the tool 10 is displaced axially toward the rim 30. The cam surface 22 engages the edges E of the rim 30 defining the hole H and facilitates movement of the tool 10 therethrough to center the hole H relative to the stud S. If the hole H is too small or otherwise deformed, the cam surface 22 substantially aligns the hole H relative to the stud S without further need for the outer cylindrical surface 17 to extend therethrough. In either case, the cam surface 22 facilitates substantial alignment of the rim along at least one axis. As shown in FIG. 4, a second tool 10′ may be threaded and tightened on another one of the studs S to further align the rim relative to the hub along a second axis. FIG. 5 shows the rim illustratively aligned relative to the hub and the studs extending from the hub. The lug nuts are then tightened on the remaining studs to lock the rim in its substantially aligned position. Once the lugs on the remaining studs are tightened, the tools 10, 10′ can be removed—the already installed lug nuts L maintain the rim 30 in the substantially aligned position. The tools 10, 10′ are replaced by regular lug nuts and the rim 30 is fully secured to the vehicle and ready for use. Thus, only two centering tools according to the present invention are required to ensure that the rim is properly aligned along two axes relative to the hub.

Referring to FIG. 6, a second embodiment of the centering tool is generally indicated at 110. In this embodiment, a shoulder 60 extends radially outwardly from the body 116 and is disposed between the first end 112 of the tool 110 and the outer cylindrical surface 117. Additionally, the threads 121 extend through a portion of the length of the tool 110 rather than the entire length of the tool, as provided in the first embodiment.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A centering tool for aligning a vehicle rim relative to a hub of a vehicle, wherein the rim includes a plurality of mounting holes for receiving axially extending studs from the hub, said tool comprising:
a body having a first end and an opposite second end, the first end being adapted to engage a torque applying tool, the body having an outer cylindrical surface that extends from the second end and allows generally axial insertion of the tool through one of the mounting holes in the rim while substantially limiting the radial movement of the rim relative to the centering tool;
a bore extending longitudinally through the body and through both the first end and second end of the body, the bore having threads for threadingly engaging a stud extending through the one of the mounting holes in the rim; and
a cam surface formed on the second end of the body, the cam surface being angled relative to a longitudinal axis of the body such that axial displacement of the centering tool onto the stud extending through the one of the mounting holes in the rim promotes a centering of the rim relative to the hub along at least one axis.

2. A centering tool as set forth in claim 1, wherein the threads extend through a portion of the length of the bore.

3. A centering tool as set forth in claim 1, wherein the threads extend along the entire length of the bore.

4. A centering tool as set forth in claim 1, wherein the cam surface is beveled and extends at an angle relative to a longitudinal axis of the bore, the angle of the cam surface ranging between 35 and 55 degrees.

5. A centering tool as set forth in claim 4, wherein the cam surface is angled at approximately 45 degrees relative to the longitudinal axis of the bore.

6. A centering tool as set forth in claim 1 including a radially outwardly extending shoulder disposed between the first end and the outer cylindrical surface.

7. A method of installing a rim onto a hub of a vehicle, wherein the hub includes a plurality of outwardly extending studs that extend through a corresponding plurality of holes formed in the rim, said method including the steps of:
placing the rim onto the hub so that at least two of the plurality of studs extend through respective holes in the rim;
inserting first and second centering tools as defined in claim 1 into the respective holes in the rim to engage the at least two of the plurality of studs;
threading the first centering tool to correct misalignment of the rim relative to the hub along a first axis;
threading the second centering tool to correct misalignment of the rim relative to the hub along a second axis, such that the rim is then substantially aligned relative to the hub along two axes;
threading lug nuts onto the remaining studs to hold the rim in substantial alignment with the hub; and
replacing the first and second centering tools with lug nuts to securely fasten the rim to the hub for road use.

8. A method as set forth in claim 7 including the step of centering an undersized hole relative to one of the respective studs using only the cam surface of the first centering tool, wherein the undersized hole cannot receive the outer cylindrical surface of the first centering tool therethrough.

9. A method as set forth in claim 8 including the step of centering a second undersized hole relative to another one of the respective studs using only the cam surface of the second centering tool, wherein the second undersized hole cannot receive the outer cylindrical surface of the second centering tool therethrough.

10. A method of installing a rim onto a hub of a vehicle, wherein the hub includes a plurality of outwardly extending studs that extend through a corresponding plurality of holes formed in the rim, said method including the steps of:
placing the rim onto the hub so that at least two of the plurality of studs extend through respective undersized holes in the rim;
threading the first and second centering tools as defined in claim 1 onto the studs that extend through the respective undersized holes in the rim;
centering the undersized holes in the rim relative to the respective studs using the only the cam surfaces of the first and second centering tools, wherein the undersized holes cannot accept the outer cylindrical surfaces of the first and second centering tools therethrough;
threading lug nuts onto the remaining studs to hold the rim in substantial alignment with the hub; and
replacing the first and second centering tools with lug nuts to securely fasten the rim to the hub for road use.
